(19) United States
(12) Patent Application Publication
(10) Pub. No.: US 2026/0111619 A1
(43) Pub. Date: Apr. 23, 2026

(54) SYSTEMS AND METHODS FOR PROVIDING COLLABORATIVE VISUALIZATION OF DESIGN DATA

(71) Applicant: COLAB AI INC., St. John's (CA)

(72) Inventors: Jeremy William ANDREWS, St. John's (CA); Adam Michael KEATING, St. John's (CA); Peter Jeffrey GOSSE, Conception Bay South (CA); Patrick LECKEY, Ottawa (CA)

(21) Appl. No.: 19/423,398

(22) Filed: Dec. 17, 2025

Related U.S. Application Data
(63) Continuation of application No. PCT/CA2024/051403, filed on Oct. 24, 2024.
(60) Provisional application No. 63/594,318, filed on Oct. 30, 2023.

(51) Int. Cl. G06F 30/15; G06F 30/12; G06F 111/02

(52) U.S. Cl. CPC G06F 30/15; G06F 30/12; G06F 2111/02

(57) ABSTRACT

Disclosed herein are a method and system for providing collaborative visualization of design data. The method involves identifying a product structure for the product; retrieving a set of design data related to the product from one or more external data systems; evaluating each design data to identify at least one relationship with the product and/or subcomponent(s), and defining an association between each design data and the product and/or subcomponent(s) based on the at least one relationship; receiving a request to display at least one design document related to the product within a workspace; in response to receiving the request to display the at least one design document: providing access to the at least one design document; identifying a set of related design data associated with the at least one design document according to the product structure; and providing access to the set of related design data within the workspace.

### CROSS-REFERENCE TO RELATED APPLICATION

This application is a continuation of PCT/CA2024/051403 filed on Oct. 24, 2024 which claims the benefit of U.S. Provisional Application No. 63/594,318 filed on Oct. 30, 2023, each of PCT/CA2024/051403 and U.S. Provisional Application No. 63/594,318 is hereby incorporated by reference in its entirety.

### FIELD

The described embodiments relate to systems and methods for providing collaborative visualization of design data, and specifically, in respect of design data related to a product.

### BACKGROUND

Online collaborations between different entities are now a common method of facilitating completion of projects. In addition to increasing the flexibility in which individuals can collaborate and the geographical locations where the entities are located, online collaboration systems can improve the collaboration process. For example, design projects conducted via online collaborations can improve data management and feedback tracking.

A design project typically involves various design documents for a product being developed. For complex products, multiple levels of design documents and multiple design documents for various components may be involved. It can then be challenging to integrate and visualize these various design documents in a way that facilitates collaboration.

### SUMMARY

The various embodiments described herein generally relate to methods (and associated systems configured to implement the methods) for providing collaborative visualization of design data.

In accordance with an example embodiment, there is provided a method for providing collaborative visualization of design data related to a product. The method includes identifying a product structure for the product, the product structure defining one or more hierarchical relationships between the product and one or more subcomponents of the product; retrieving a set of design data related to the product from one or more external data systems via a network; evaluating each design data of the set of design data to identify at least one relationship with the one or more of the product and the one or more subcomponents, and defining an association between each design data and the one or more of the product and the one or more subcomponents based on the at least one relationship; receiving a request to display at least one design document related to the product within a workspace; in response to receiving the request to display the at least one design document: providing, within the workspace, access to the at least one design document; identifying a set of related design data associated with the at least one design document according to the product structure; and providing access to the set of related design data within the workspace.

In some embodiments, providing, within the workspace, access to the at least one design document includes displaying the at least one design document within the workspace.

In some embodiments, the method includes receiving a feedback on the at least one design document displayed within the workspace.

In some embodiments, the method includes displaying the feedback received on the at least one design document when a related design document associated with a higher hierarchical level of the product structure is displayed.

In some embodiments, evaluating each design data of the set of design data to identify at least one relationship with the one or more of the product and the one or more subcomponents includes matching at least a part of a design data identifier associated with each design data with one or more of a product identifier associated with the product and a subcomponent identifier of the one or more subcomponents.

In some embodiments, identifying the set of related design data associated with the at least one design document according to the product structure includes determining a hierarchical level of the product structure to which the at least one design document is associated; identifying, based on the product structure, the one or more subcomponents associated with a lower hierarchical level than the hierarchical level determined for the at least one design document; and assigning one or more design data associated with the one or more subcomponents at the lower hierarchical level as the set of related design data.

In some embodiments, the request to display the at least one design document related to the product includes a request to display a design document related to a subcomponent of the product.

In some embodiments, each subcomponent is associated with at least an engineering requirement, a bill of materials reference, a design drawing reference, and a CAD model reference.

In accordance with an example embodiment, there is provided a collaborative visualization system for visualizing design data related to a product. The system includes a data storage operable to store one or more product structures, each product structure defining one or more hierarchical relationships between each product and one or more subcomponents of that product; and a processor configured to identify, from the data storage, a product structure for the product; retrieve a set of design data related to the product from one or more external data systems via a network; evaluate each design data of the set of design data to identify at least one relationship with the one or more of the product and the one or more subcomponents, and define an association between each design data and the one or more of the product and the one or more subcomponents based on the at least one relationship; receive a request to display at least one design document related to the product within a workspace; and in response to receiving the request to display the at least one design document provide, within the workspace, access to the at least one design document; identify a set of related design data associated with the at least one design document according to the product structure; and provide access to the set of related design data within the workspace.

In some embodiments, the processor is configured to display the at least one design document within the workspace.

In some embodiments, the processor is configured to receive a feedback on the at least one design document displayed within the workspace.

In some embodiments, the processor is configured to display the feedback received on the at least one design document when a related design document associated with a higher hierarchical level of the product structure is displayed.

In some embodiments, the processor is configured to match at least a part of a design data identifier associated with each design data with one or more of a product identifier associated with the product and a subcomponent identifier of the one or more subcomponents.

In some embodiments the processor is configured to determine a hierarchical level of the product structure to which the at least one design document is associated identify, based on the product structure, the one or more subcomponents associated with a lower hierarchical level than the hierarchical level determined for the at least one design document; and assign one or more design data associated with the one or more subcomponents at the lower hierarchical level as the set of related design data.

In some embodiments, the request to display the at least one design document related to the product includes a request to display a design document related to a subcomponent of the product.

In some embodiments, each subcomponent is associated with at least an engineering requirement, a bill of materials reference, a design drawing reference, and a CAD model reference.

In accordance with an example embodiment, there is provided a method for providing collaborative visualization of design data related to a product. The method includes receiving a request to display at least one design document related to the product within a workspace; identifying a product structure for the product, the product structure defining one or more hierarchical relationships between the product and one or more subcomponents of the product; providing, within the workspace, access to the at least one design document; identifying a set of related design data associated with the at least one design document according to the product structure; and providing access to the set of related design data within the workspace.

In some embodiments, providing, within the workspace, access to the at least one design document includes displaying the at least one design document within the workspace.

In some embodiments, the method includes receiving a feedback on the at least one design document displayed within the workspace.

In some embodiments, the method includes displaying the feedback received on the at least one design document when a related design document associated with a higher hierarchical level of the product structure is displayed.

In some embodiments, identifying the set of related design data associated with the at least one design document according to the product structure includes determining a hierarchical level of the product structure to which the at least one design document is associated; identifying, based on the product structure, the one or more subcomponents associated with a lower hierarchical level than the hierarchical level determined for the at least one design document; and assigning one or more design data associated with the one or more subcomponents at the lower hierarchical level as the set of related design data.

In some embodiments, the request to display the at least one design document related to the product includes a request to display a design document related to a subcomponent of the product.

In some embodiments, each subcomponent is associated with at least an engineering requirement, a bill of materials reference, a design drawing reference, and a CAD model reference.

In accordance with an example embodiment, there is provided a collaborative visualization system for visualizing design data related to a product. The system includes a data storage operable to store one or more product structures, each product structure defining one or more hierarchical relationships between each product and one or more subcomponents of that product; and a processor configured to receive a request to display at least one design document related to the product within a workspace; identify a product structure for the product, the product structure defining one or more hierarchical relationships between the product and one or more subcomponents of the product; provide, within the workspace, access to the at least one design document; identify a set of related design data associated with the at least one design document according to the product structure; and provide access to the set of related design data within the workspace.

In some embodiments, the processor is configured to display the at least one design document within the workspace.

In some embodiments, the processor is configured to receive a feedback on the at least one design document displayed within the workspace.

In some embodiments, the processor is configured to display the feedback received on the at least one design document when a related design document associated with a higher hierarchical level of the product structure is displayed.

In some embodiments, the processor is configured to determine a hierarchical level of the product structure to which the at least one design document is associated; identify, based on the product structure, the one or more subcomponents associated with a lower hierarchical level than the hierarchical level determined for the at least one design document; and assign one or more design data associated with the one or more subcomponents at the lower hierarchical level as the set of related design data.

In some embodiments, the request to display the at least one design document related to the product includes a request to display a design document related to a subcomponent of the product.

In some embodiments, each subcomponent is associated with at least an engineering requirement, a bill of materials reference, a design drawing reference, and a CAD model reference.

### BRIEF DESCRIPTION OF THE DRAWINGS

Several embodiments will now be described in detail with reference to the drawings, in which:

FIG. 1 is a block diagram of components interacting with a collaborative visualization system in accordance with an example embodiment;

FIG. 2 is a block diagram of components of an example collaborative visualization system in accordance with an example embodiment;

FIG. 3 is a flowchart of an example method for providing collaborative visualization of design data;

FIG. 4 is a photograph of an example product;

FIG. 5A is a graphical representation of an example product structure for the product shown in FIG. 4;

FIG. 5B is a graphical representation of another example product structure for the product shown in FIG. 4;

FIG. 6 is a graphical representation of example product structures in accordance with an example embodiment;

FIG. 7A is an example user interface of a workspace in accordance with an example embodiment;

FIG. 7B is another example embodiment of the user interface of FIG. 7A;

FIG. 7C is another example embodiment of the user interface of FIG. 7A;

FIG. 7D is another example embodiment of the user interface of FIG. 7A; and

FIG. 8 is a flowchart of another example method for providing collaborative visualization of design data.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

In the product development process, various design documents related to the product need to be organized and stored. To this end, organizations often make use of external data systems, such as but not limited to Product Lifecycle Management (PLM) and Product Data Management (PDM) systems to oversee and facilitate the product development process.

Generally, PLM systems can offer a broad, comprehensive view of the project development process. They can facilitate project management with features, such as collaboration tools, cost analysis software, and regulatory compliance oversight. This facilitates cross-functional collaboration within the organization, particularly between engineering and design teams as well as manufacturing, marketing, and sales, throughout an entire product development lifecycle. Each of these teams, interact with the product in various ways and may provide various design documents related to the product. PDM systems can capture a narrower, complimentary application by enabling organizations to manage and store design documents related to a product's design. These include, for example, computer-aided design (CAD) files, requirements documents, or bills of materials (BoMs). PDMs typically offer features such as restricting how many users can edit a document at one time, document versioning, and access privileges to thwart unauthorized parties from obtaining sensitive files. PDMs provide a product development team with better control over the product development process by limiting duplicative work or preventing critical files from being accidentally deleted.

However, for large organizations with many products, often developed as product lines, or, for a single, complex product having multiple subcomponents, the basic features offered by these external data systems can be insufficient for enabling collaborative visualization, especially for a design review process. One challenge that these external data systems faces is that the volume of design documents in these external data systems cannot be engaged in a visual form that is based on the product structure. When engaging with these external data systems for design, the review process can be limited in that the documents related to individual components are reviewed alone, without context of the related components, product and/or feedback from related workspaces.

Also, some organizations update their product lines each year with the release of new versions of their products. Each year's new release can still use subcomponents from the previous year(s). More often than not, the new release can incorporate the design data related to the previous year(s)′ subcomponents without necessarily duplicating all design data.

Further, some collaborative design projects may involve multiple organizations. These design documents can originate from multiple external data systems. However, although the design documents may relate to the same products and subcomponents, they would not be associated with each other. As a result, various issues including duplication of work, missed feedback, and series workflows will frequently occur and inhibit the effectiveness of collaboration.

The various embodiments described herein generally relate to systems and methods for providing collaborative visualization of design data related to a product. As will be described, the disclosed methods and systems enable design data from different external data systems to be associated with a product structure so that appropriately related design data can be identified during the collaborative visualization process.

The disclosed methods, for example, can involve identifying a product structure for the product. The product structure defines one or more hierarchical relationships between the product and one or more subcomponents of the product. At a high level, a product structure identifies the parts that combine to make the overall product. The product structure can be depicted as a hierarchy of components. For example, at the top of the hierarchy is the product, and each lower hierarchical level of the product structure includes the subcomponents of the product. The collaborative visualization system described herein can then retrieve a set of design data related to the product from one or more external data systems. The collaborative visualization system can then evaluate each design data to identify at least one relationship with the one or more of the product and the one or more subcomponents. An association can then be defined between each design data and the product and/or the one or more subcomponents based on the at least one relationship. When a request to display a design document is received via a workspace, the collaborative visualization system can provide access to the at least one design document while also identifying a set of related design data associated with that document according to the product structure. The collaborative visualization system can then provide access to the set of related design data.

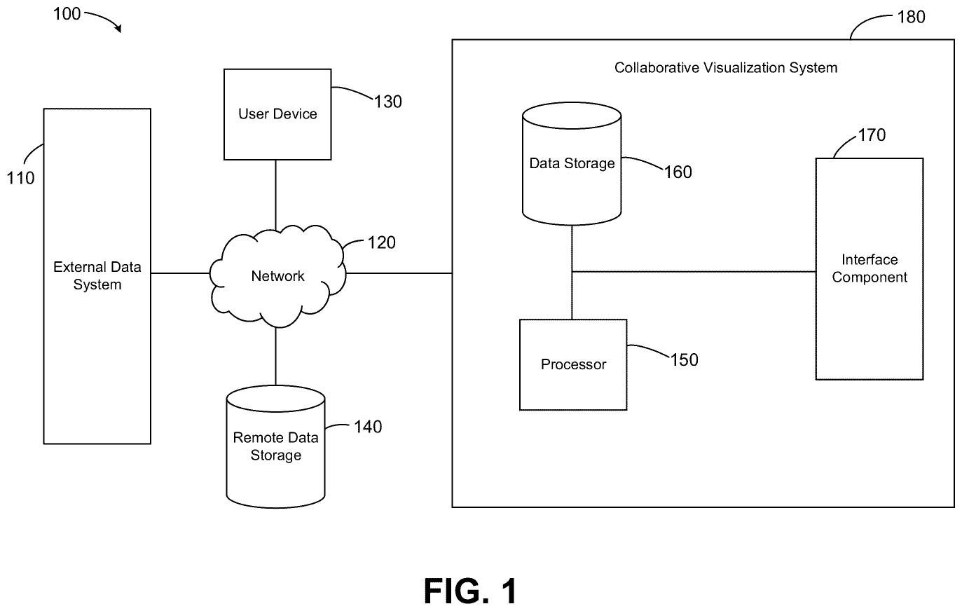

Reference is now made to FIG. 1, which illustrates a block diagram of components interacting with a collaborative visualization system 180 in accordance with an example embodiment. As shown in FIG. 1, the collaborative visualization system 180 can be in communication with an external data system 110, a user device 130 and a remote data storage 140 via a network 120.

The collaborative visualization system 180 includes a processor 150, a data storage 160, and an interface component 170. The processor 150, the data storage 160, and the interface component 170 may be implemented in software or hardware, or a combination of software and hardware. The processor 150, the data storage 160, and the interface component 170 can be combined into a fewer number of components or may be separated into further components. The collaborative visualization system 180 may, in some embodiments, be split into multiple computing systems that may be distributed over a wide geographic area and connected via the network 120.

The processor 150 is configured to control the operation of the collaborative visualization system 180. The processor 150 may be any suitable processors, controllers or digital signal processors that can provide sufficient processing power depending on the configuration, purposes and requirements of the collaborative visualization system 180. In some embodiments, the processor 150 can include more than one processor with each processor being configured to perform different dedicated tasks. For example, the processor 150 can identify from the data storage 160, a product structure for a product, and retrieve a set of design data related to the product from the external data system 110 via the network 120.

The data storage 160 can include RAM, ROM, one or more hard drives, one or more flash drives or some other suitable data storage elements such as disk drives, etc. For example, the data storage 160 can also store product structures related to multiple different products, and related data, such as but not limited to design documents and metadata related to the products and the design documents. For example, and not of limitation, the design documents can include a computer-aided design file (CAD) in various formats, an image file (JPG, JPEG, GIF, PNG, a scalable vector graphics file (SVG), or any combination of these documents.

The interface component 170 may be any interface that enables the collaborative visualization system 180 to communicate with other devices and systems. The interface component 170 may also include at least one of an Internet, Local Area Network (LAN), Ethernet, Firewire, modem or digital subscriber line connection. Various combinations of these elements may be incorporated within the interface component 170. For example, the interface component 170 may receive input from various input devices, such as a mouse, a keyboard, a touchscreen, a thumbwheel a track-pad, a track-ball, a card-reader, voice recognition software and the like depending on the requirements and implementation of the collaborative visualization system 180.

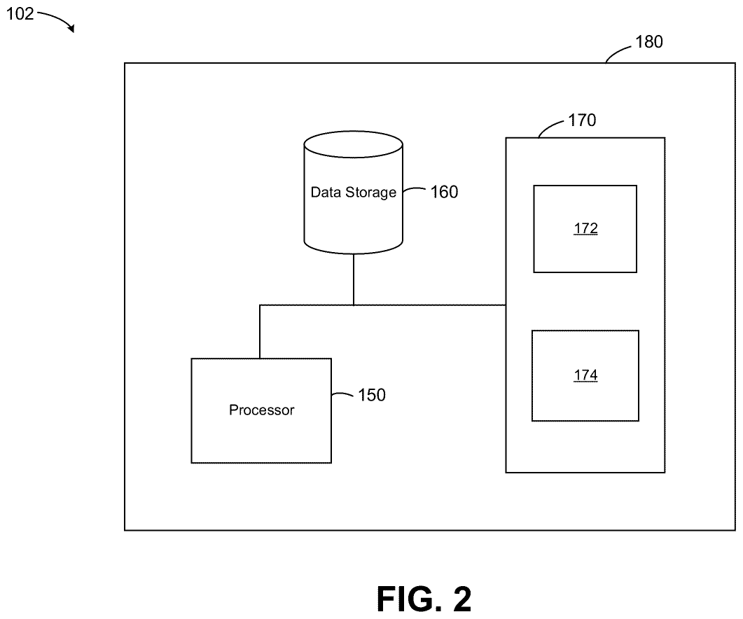

Further, the interface component 170 can provide a user interface (UI) for a user to interact with the collaborative visualization system 180. The user interface provided by the interface component 170 can enable the user to interact with the collaborative visualization system 180 in a number of ways, including but not limited to, interacting with design documents, and/or submitting feedback related to the design documents. For example, FIG. 2 shows a block diagram 102 of example components of the collaborative visualization system 180. The collaborative visualization system 180, via the interface component 170, can offer a user interface via which design documents 172 and related design data 174 can be shown.

The external data system 110, as described above, may share with and/or receive design data from the collaborative visualization system 180 via the network 120. The external data system 110 may include various different data and/or project management systems, such as but not limited to PDM systems and PLM systems. Although only one external data system 110 is shown for ease of exposition, it will be understood that more than one external data system 110 can communicate with the collaborative visualization system 180 at any one time. In some embodiments, the external data system 110 can share design data with the collaborative visualization system 180 contemporaneously and/or successively with other external data systems 110.

The remote data storage 140 can include RAM, ROM, one or more hard drives, one or more flash drives or some other suitable data storage elements. The remote data storage 140 may also include one or more database(s) or file system(s). Although only one remote data storage 140 is shown for ease of exposition, there may be multiple remote data storage 140 distributed over a wide geographic area and connected via the network 120. The remote data storage 140 can be used to store back-up data in some embodiments, and/or data less frequently accessed by the collaborative visualization system 180. For example, the remote data storage 140 can store data related to completed projects and/or inactive users.

The user device 130 may be any networked device operable to connect to the network 120. A networked device is a device capable of communicating with other devices through a network such as the network 120. A networked device may couple to the network 120 through a wired or wireless connection. These external user devices 130 may include at least a processor and a data storage, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. Although only one user device 130 is shown, it will be understood that more than one user device 130 can communicate with the collaborative visualization system 180 at any one time via the network 120. The user device 130 can be used by a user, whether a user internal to the organization using the collaborative visualization system or a third-party user external to that organization, to access the collaborative visualization system 180. In some embodiments, a connection request initiated from the user device 130 may be initiated from a web browser or application and directed at the browser-based or application-based interface offered by the interface component 170 of the collaborative visualization system 180.

The network 120 may be any network capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these, capable of interfacing with, and enabling communication between the collaborative visualization system 180, the user device 130, and the remote data storage 140.

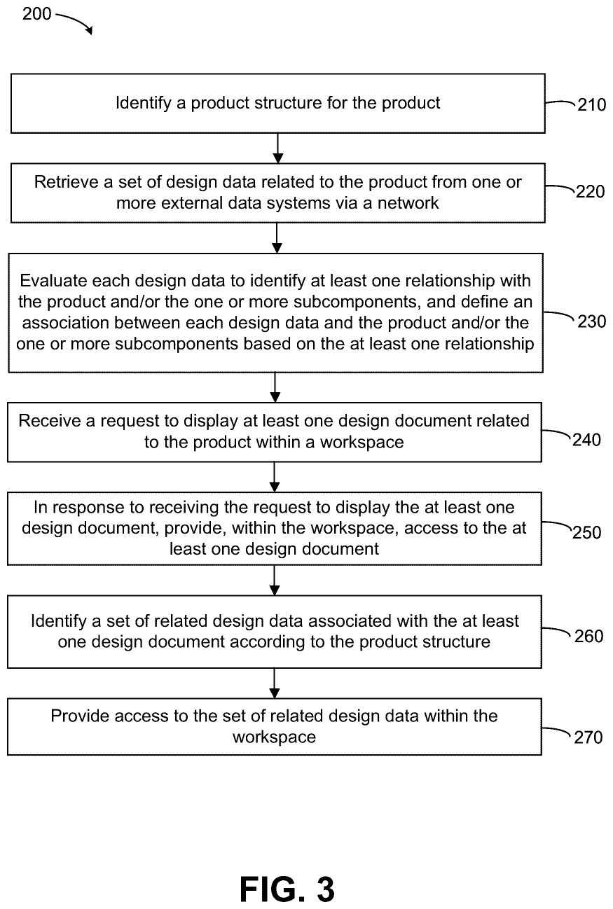

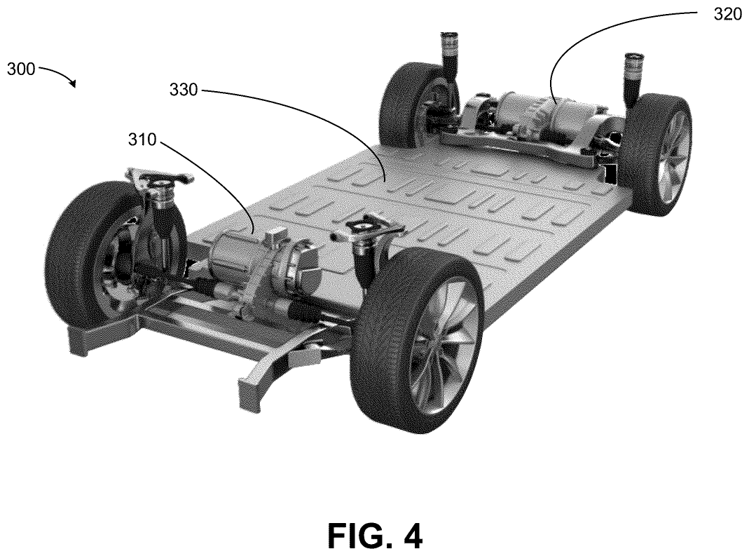

Referring now to FIG. 3, which is a flowchart 200 of an example method for providing the collaborative visualization of design data related to a product. To illustrate the method, reference will be made to FIGS. 4 to 7B. FIG. 4 is a photograph of an example product, namely an electric vehicle powertrain 300 with various subcomponents, such as a rear drive unit 320, a battery pack 330, and a front drive unit 310.

At 210, the processor 150 identifies a product structure for the product 300.

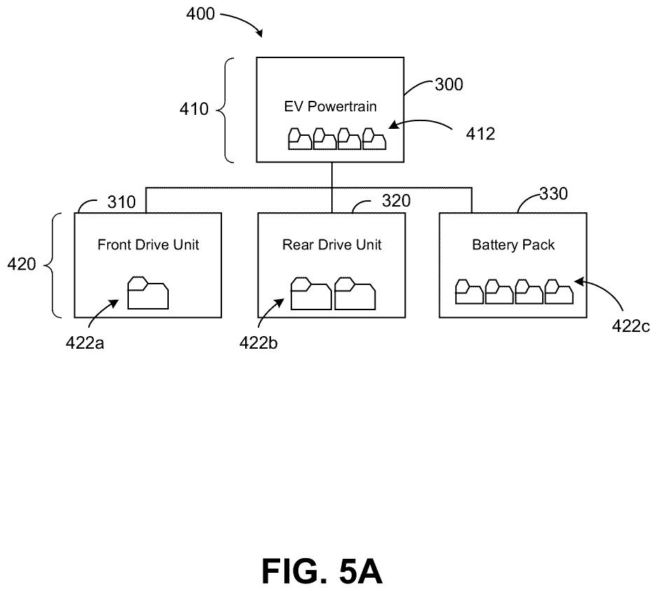

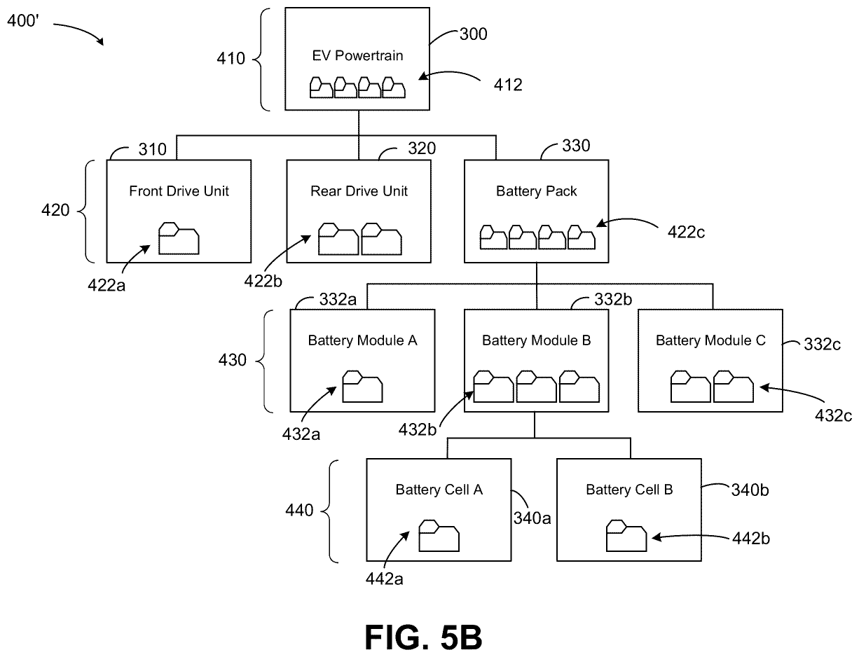

As described, the product structure can define hierarchical relationships between the product 300 and subcomponent(s) of the product 300, such as 310, 320 and 330. An example product structure 400 for the powertrain 300 is shown in FIG. 5A.

The product structure 400 includes subcomponents 310, 320 and 330 in a hierarchical relationship with the product 300 with hierarchical levels 410 and 420. Each product 300 and subcomponents 310, 320 and 330 can be represented as a node within the product structure 400. The graphical representation of the product structure 400 shown in FIG. 5A is for illustrative purposes and other manners of storing the relationship between the product 300 and the subcomponents 310, 320 and 330 can be applied. At the first hierarchical level 410 is the product 300 and the subcomponents (the battery pack 330, the rear drive unit 320, and the front drive unit 310) are at the second hierarchical level 420.

Each node 300, 310, 320, 330 within the product structure 400 can be associated with a set of design data. The set of design data can include one or more design data. For example, as shown in FIG. 5A, node 300 is associated with design data 412, node 310 is associated with design data 422a, node 320 is associated with design data 422b, and node 330 is associated with design data 422c. The set of design data associated with each node can vary depending on various factors, such as the type of product and/or the type of design required. Some example design data can include, but not limited to, an engineering requirement, a bill of materials, a design drawing, and a CAD model, or any combination of these. For illustrative purposes, the sets of design data 412, 422a, 422b, and 422c are shown to include different number of design data. It may be that each node is required to be associated with the same type of design data in some embodiments.

FIG. 5B shows another example product structure 400′ for the powertrain 300. Similar to the product structure 400 in FIG. 5A, the product structure 400′ includes subcomponents 310, 320 and 330 in a hierarchical relationship with the product 300 with hierarchical levels 410 and 420. The product structure 400′ is further expanded to include the product structure of the battery pack 330, which includes a first hierarchical level 430 and a second hierarchical level 440. When referenced within the context of the product structure 400′, the first hierarchical level 430 may be referred to as the third hierarchical level 430 and the second hierarchical level 440 may be referred to as the fourth hierarchical level 440. For illustrative purposes, the product structure of the battery pack 330 is shown in FIG. 5B. It will be understood that each of the nodes 310 and 320 can be associated with a different product structure, respectively.

The battery pack 330 node is associated with a battery module A 332a, a battery module B 332b, and a battery module C 332c at the third hierarchical level 430. Further, the battery module B 332b is associated with a battery cell A 340a and a battery cell B 340b at the fourth hierarchical level 440. Although not shown in FIG. 5B, it will be understood that each of the nodes 332a and 332c can be associated with a different product structure, respectively. Similarly, each node 332a, 332b, 332c, 340a, and 340b is associated with a set of design data 432a, 432b, 432c, 442a and 442b, respectively.

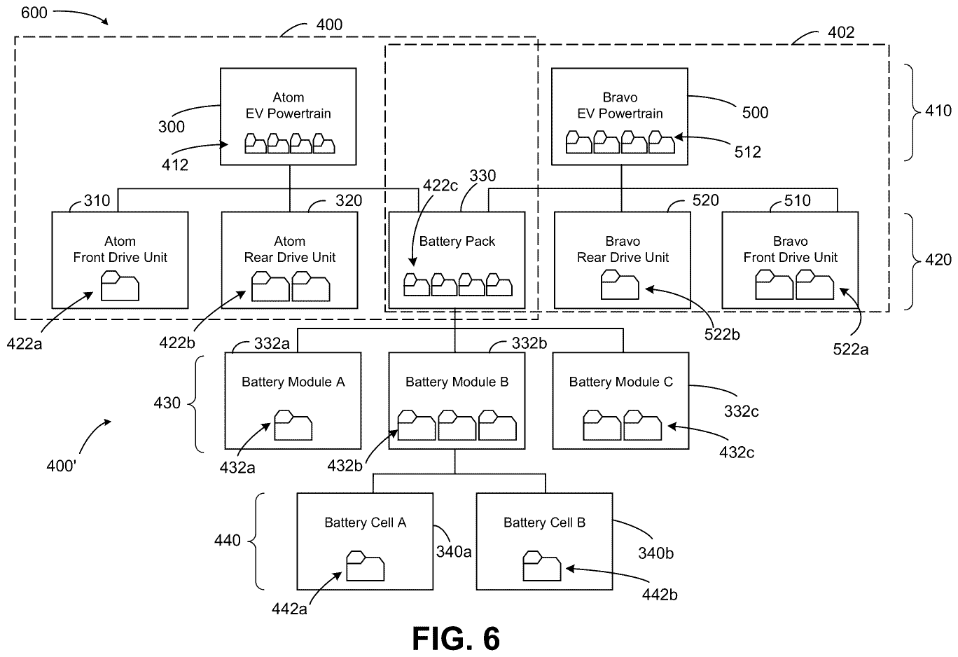

FIG. 6 shows a graphical representation 600 of product structures. In FIG. 6, the product structure 400′ of FIG. 5B is shown (which has been identified as for Atom EV Powertrain. In addition, the product structure 402 for another powertrain 500 (Bravo EV powertrain) is shown. The product structure 402 is similar to that of the product structure 400′ shown in FIG. 5B in that the product structure 500 includes subcomponents 510, 520 and 330 in a hierarchical relationship with the product 500 with hierarchical levels 410 and 420. As shown, the products 300, 500 share the same battery pack 330 and so, the battery pack 330 product structure is common between the products 300, 500.

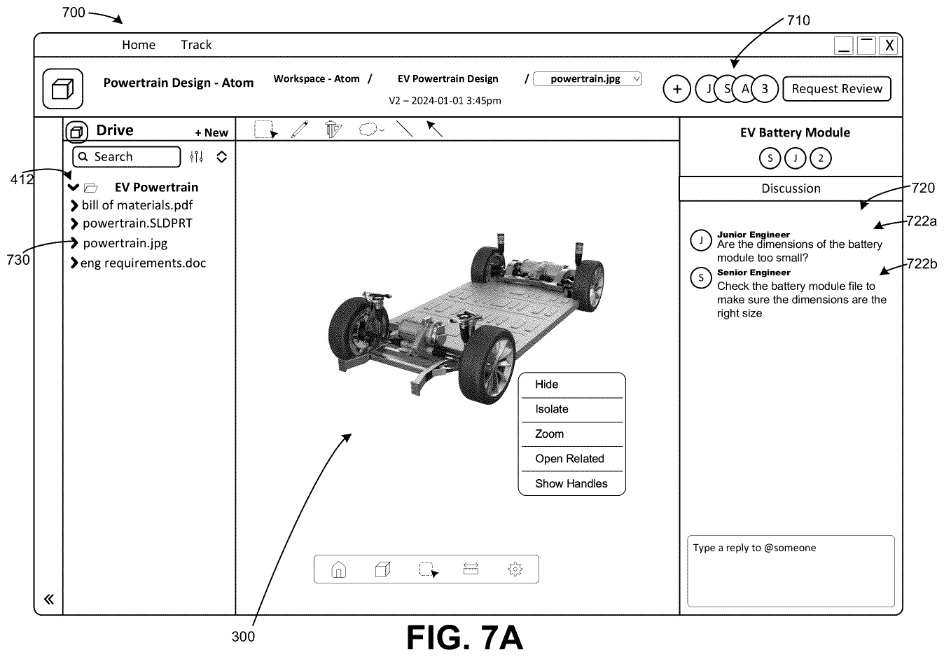

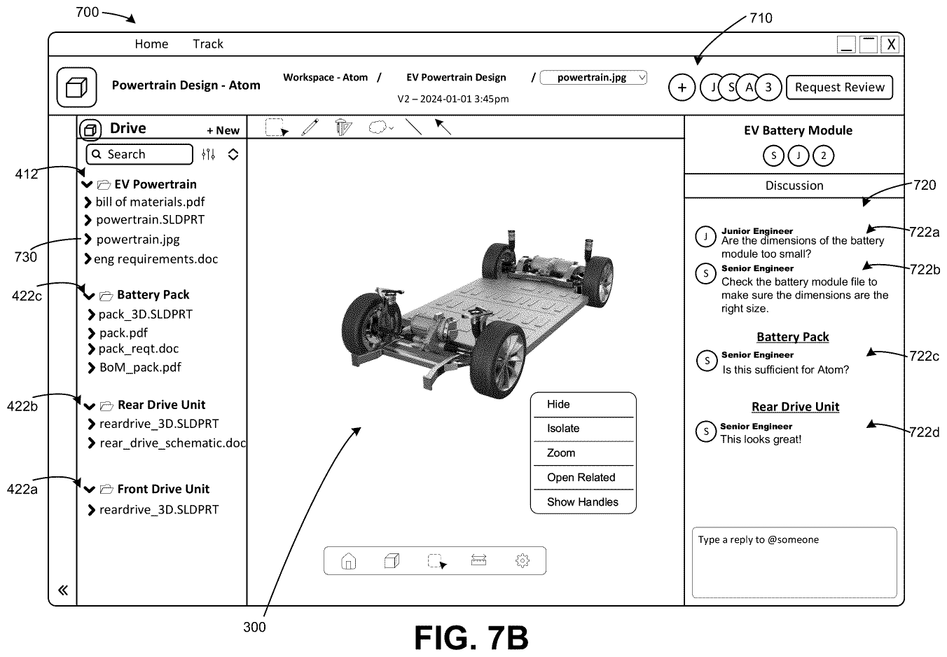

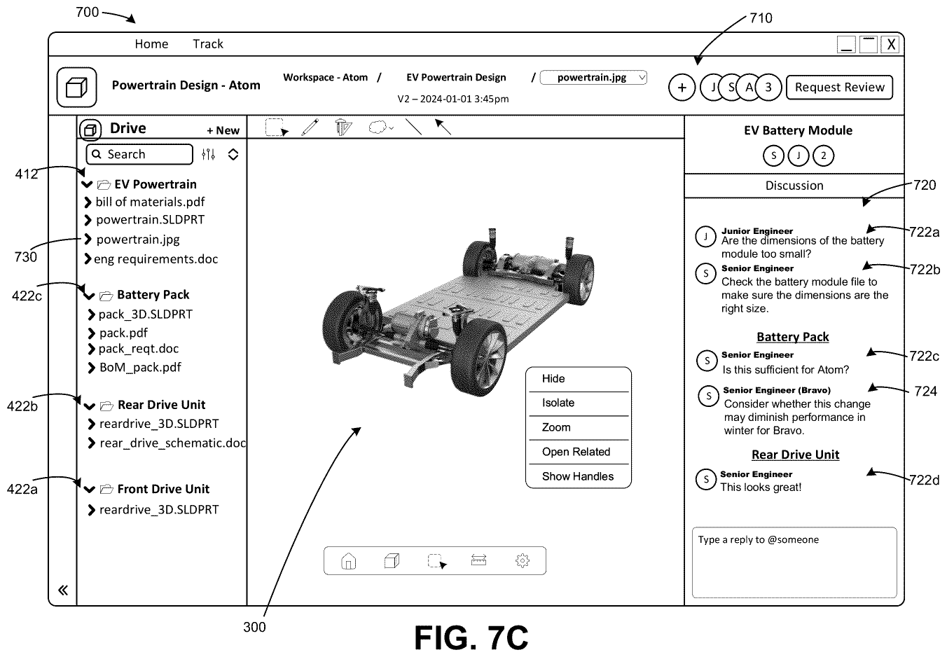

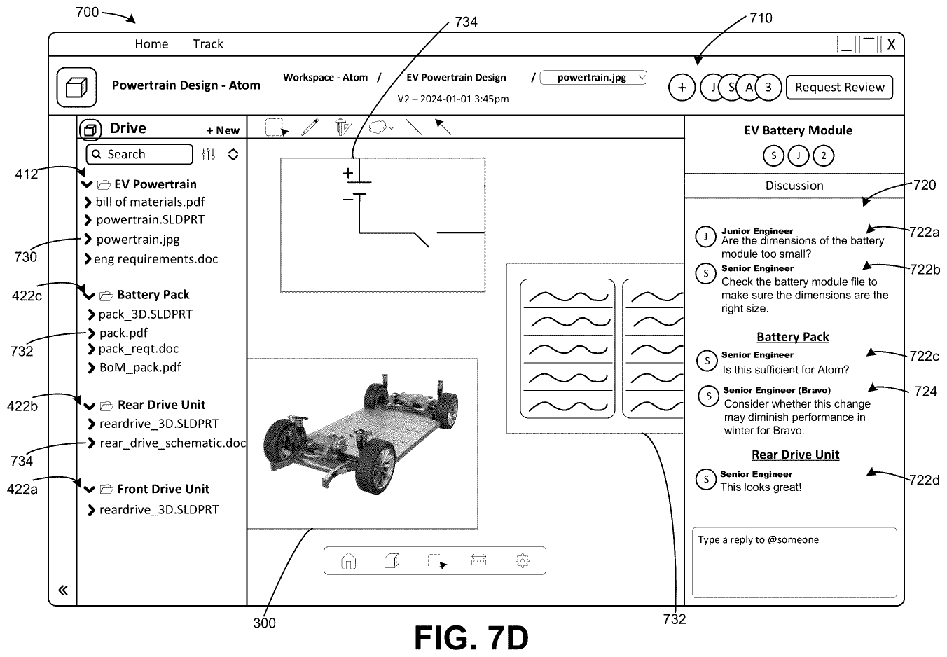

As described, some organizations may have multiple product lines but those products may share subcomponents. In the example shown in FIG. 6, an electric automotive company may have an “Atom” EV product line and a “Bravo” EV product line within their EV fleet. Both Atom and Bravo can use the same EV battery pack design (e.g., 330). Instead of having to duplicate all the design data associated with the battery pack 330, each of the product structures 400, 402 can reference the product structure associated with the battery pack 330. In this way, when designers are working on the design of the battery pack 330, any such feedbacks and edits made to that design will be available for each of the “Atom” and “Bravo” design teams (as will be described with reference to FIG. 7C).

At 220, the processor 150 retrieves a set of design data related to the product 300 from one or more external data systems 110 via the network 120.

The processor 150 can retrieve the set of design data associated with the product 300 from an external data system 110. The set of design data can include design data associated with subcomponents 310, 320, 330 of the product 300. As described, the set of design data can include, but are not limited to or are not required to (depending on system or design requirements), an engineering requirement, a bill of materials, a design drawing, and a CAD model. The set of design data can also be a reference to the design file(s) so that the processor 150 can proceed to retrieve the relevant design documents from the data storage 160 and/or the remote data storage 140, where applicable. In some embodiments, the processor 150 may not need to retrieve the associated design data but can rely on the reference to the design data.

At 230, the processor 150 evaluates each design data of the set of design data to identify at least one relationship with the product 300 and/or the subcomponent(s) 310, 320, 330. The processor 150 then defines an association between each design data and the product 300 and/or the subcomponents 310, 320, 330 based on the at least one relationship.

The collaborative visualization system 180 can receive the set of design data from the external data system 110. In some embodiments, the collaborative visualization system 180 can receive design data from different external data systems 110. The set of design data can include data related to the product 300 as well as each of the subcomponents 310, 320, 330.

When received, the processor 150 can evaluate the set of design data to identify any relationship between each design data with the product 300 and/or each subcomponent 310, 320, 330. To determine whether there is any relationship between a design data and the product 300 and/or each subcomponent 310, 320, 330, the processor 150 can evaluate the metadata of the design data and/or design data identifiers. A design data identifier can include information, such as, but not limited to, a file name, an author, a part number, and a document number. The metadata can include, but not limited to, a date that the design data was created or last modified, a file type or format, a file size, a version number, keywords or tags, a document number, and a location or path the design data is saved, or any combination of these. The processor 150 can then determine how each design data is associated with the product 300 and/or subcomponent(s) 310, 320, 330. It may be that one design data can be associated with multiple nodes. For example, the collaborative visualization system 180 can receive design data related to the product 300 from two external data systems 110, but the design data follow different naming conventions, or the design data from each external data system 110 is intended to complement the other. The processor 150 can evaluate each to identify the appropriate relationship to the product 300 and associated subcomponents 310, 320, 330. For example, the processor 150 can match at least a part of a design data identifier associated with each design data with one or more of a product identifier associated with the product 300 and a subcomponent identifier of the one or more subcomponents 310, 320, 330.

At 240, the processor 150 receives a request to display at least one design document related to the product 300 within a workspace, and, at 250, in response to receiving the request to display the at least one design document 730, the processor 150 provides, within the workspace 710, access to the at least one design document 730.

FIG. 7A shows an example user interface 700 for a workspace 710 of the collaborative visualization system 180. As can be seen, the design document 730 (photograph of the product 300) is displayed. The workspace 710 is an electronic environment offered by the collaborative visualization system 180 via which users can review design documents and share feedback on the design documents. The request can include a request to display a design document related to a subcomponent 310, 320, 330.

At 260, the processor 150 identifies a set of related design data associated with the at least one design document 730 according to the product structure 400.

Continuing with the product structure 400 identified at 210, the processor 150 can determine the set of related design data based on the product structure 400. As the design document 730 relates to the powertrain 300, the processor 150 can determine from the product structure 400 that the subcomponents 310, 320 and 330 are associated with the powertrain 300. The processor 150 can then identify the set of related design data to include the sets of design data 422a, 422b, 422c associated with the subcomponents 310, 320 and 330, respectively.

In some embodiments, the processor 150 can identify the set of related design data associated with the design document 730 by determining a hierarchical level of the product structure 400 to which the design document 730 is associated. For example, with reference to FIG. 5A, the processor 150 can determine that the design document 730 is part of the design data 412, which is at the first hierarchical level 410 of the product structure 400. The processor 150 can then identify, based on the product structure 400, the components associated with a lower hierarchical level than the first hierarchical level 410, which, includes subcomponents 310, 320, 330 (at the second hierarchical level 420).

At 270, the processor 150 provides access to the set of related design data within the workspace 710.

Continuing to FIG. 7B, the user interface 700 can provide access to the sets of related design data 422a, 422b, 422c associated with subcomponents 310, 320, 330, respectively.

Further, the user interface 700 can include a discussion component 720 via which feedback can be received from the users involved with the collaboration. For example, in FIG. 7A, feedbacks 722a and 722b can be received in respect of the product 300 shown in the workspace 710. In some embodiments, the set of related design data can include the feedback(s) received in respect of the associated subcomponents. For example, in FIG. 7B, when the processor 150 provides access to the sets of related design data 422a, 422b, 422c, the sets of related design data 422a, 422b, 422c can include the feedback, such as feedbacks 722c and 722d received, in respect of those subcomponents. The feedback 722c and 722d, for example, can be received in respect of design documents related to the design document 730, such as design documents associated with subcomponents at a lower hierarchical level than the design document 730. Such related feedback can be available to users of the workspace 710, in some embodiments.

In another example, FIG. 7C shows a user interface 700 where the feedback 724 received from another workspace, such as the workspace used by the Bravo design team, can also be illustrated in the Atom workspace 710 when the processor 150 includes common design data, such as the set of design data 422c related to the battery pack 330. The collaborative visualization system 180 can limit the extent to which feedback received from different workspaces can be viewed based on permission settings, for example.

Similarly, when the design data selected is a primary document that forms the basis of various other design data, the processor 150 can identify the design data driven by that primary document with reference to the associated product structure. For example, the primary document can be an engineering requirements document, which sets the parameters for various design data, such as CAD models and/or drawings. With those design data, any feedback provided in association with those design data can also be provided to the user who had requested access to the engineering requirements. As a result, the user can quickly gain access to see all relevant design data, including feedback generated in respect of those design data.

In another example, FIG. 7D shows a user interface 700 where multiple design data are shown within the workspace 710. The design data can include any design data within the set of related design data and/or other design data accessible via the workspace 710. In this example, FIG. 7D shows the photograph of the powertrain 300 from FIG. 4, as well as a PDF design document 732 associated with the battery pack 422c and a schematic design document 734 associated with the rear drive unit. The design data can be organized with respect to each other within the workspace 710. The processor 150 can also generate documents and/or presentations based on the design data (or design blocks) included within the workspace 710. The workspace 710 can operate as a collaborative whiteboard or canvas via which multiple users can collaboratively visualize a design project, including reviewing an overall progress of the design project. The design data available via this collaborative whiteboard can be available in real time.

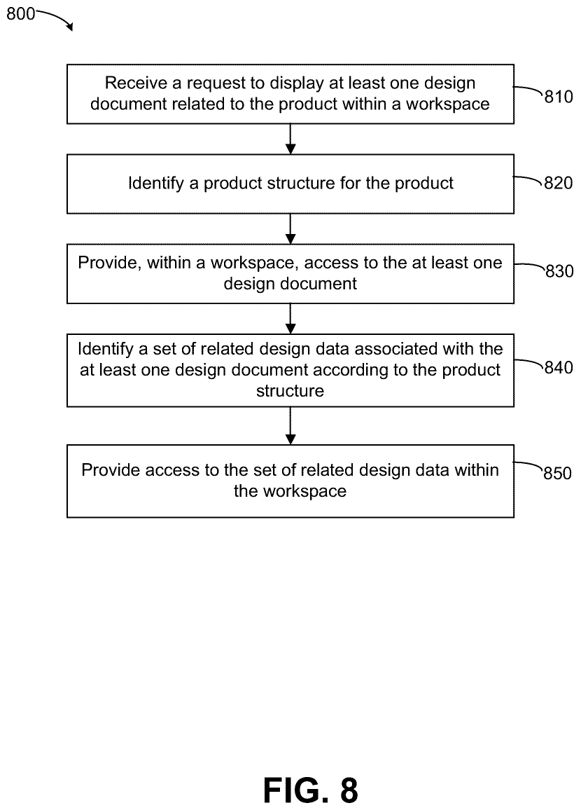

FIG. 8 is a flowchart 800 of another example method for providing collaborative visualization of design data related to a product, such as 300.

At 810, the processor 150 receives a request to display at least one design document 730 related to the product 300 within a workspace 710. The request to display the at least one design document can include a request to display a design document related to a subcomponent of the product 300.

At 820, the processor 150 identifies a product structure 400 for the product 300. As described with reference to 210 of FIG. 3, the product structure 400 can define hierarchical relationships between the product 300 and subcomponent(s) of the product 300, such as 310, 320 and 330. Example product structures 400, 400′, 402 are described with reference to FIGS. 5A, 5B and 6.

At 830, the processor 150 provides, within the workspace 710, access to the at least one design document 730.

In some embodiments, the processor 150 can display feedback received on the at least one design document 730 when a related design document associated with a higher hierarchical level of the product structure 400 is displayed. For example, as shown in FIG. 7B, the feedbacks 722c and 722d received in respect of subcomponents 330 and 320 are displayed despite the design document 730 is associated with the product 300, which is at a higher hierarchical level than the hierarchical level of the subcomponents 320 and 330.

At 840, the processor 150 identifies a set of related design data according to the product structure 400. In some embodiments, the processor 150 can identify the set of related design data by determining a hierarchical level of the product structure 400 to which the design document 730 is associated and identify, based on the product structure 400, the subcomponent(s) associated with a lower hierarchical level than the hierarchical level determined for the at least one design document 730. The processor 150 can then assign the design data associated with the subcomponents at the lower hierarchical level as the set of related design data.

At 850, the processor 150 provides access to the set of related design data within the workspace 710. Example embodiments are described with reference to FIGS. 7A, 7B and 7C.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one interface component. For example and without limitation, the programmable computers (user devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the interface component may be a network interface component. In embodiments in which elements are combined, the interface component may be a software interface component, such as those for inter-process communication (IPC). In still other embodiments, there may be a combination of interface components implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

We claim:

1. A method for providing collaborative visualization of design data related to a product, the method comprising:
identifying a product structure for the product, the product structure defining one or more hierarchical relationships between the product and one or more subcomponents of the product;
retrieving a set of design data related to the product from one or more external data systems via a network;
evaluating each design data of the set of design data to identify at least one relationship with the one or more of the product and the one or more subcomponents, and defining an association between each design data and the one or more of the product and the one or more subcomponents based on the at least one relationship;
receiving a request to display at least one design document related to the product within a workspace;
in response to receiving the request to display the at least one design document:
providing, within the workspace, access to the at least one design document;
identifying a set of related design data associated with the at least one design document according to the product structure; and
providing access to the set of related design data within the workspace.

2. The method of claim 1, wherein providing, within the workspace, access to the at least one design document comprises:
displaying the at least one design document within the workspace.

3. The method of claim 2 further comprises:
receiving a feedback on the at least one design document displayed within the workspace.

4. The method of claim 3 further comprises:
displaying the feedback received on the at least one design document when a related design document associated with a higher hierarchical level of the product structure is displayed.

5. The method of claim 1, wherein evaluating each design data of the set of design data to identify at least one relationship with the one or more of the product and the one or more subcomponents comprises:
matching at least a part of a design data identifier associated with each design data with one or more of a product identifier associated with the product and a subcomponent identifier of the one or more subcomponents.

6. The method of claim 1, wherein identifying the set of related design data associated with the at least one design document according to the product structure comprises:
determining a hierarchical level of the product structure to which the at least one design document is associated;
identifying, based on the product structure, the one or more subcomponents associated with a lower hierarchical level than the hierarchical level determined for the at least one design document; and
assigning one or more design data associated with the one or more subcomponents at the lower hierarchical level as the set of related design data.

7. The method of claim 1, wherein the request to display the at least one design document related to the product comprises a request to display a design document related to a subcomponent of the product.

8. The method of claim 1, wherein each subcomponent is associated with at least an engineering requirement, a bill of materials reference, a design drawing reference, and a CAD model reference.

9. A system for providing collaborative visualization of design data related to a product, the system comprising:
a data storage operable to store one or more product structures, each product structure defining one or more hierarchical relationships between each product and one or more subcomponents of that product; and
a processor configured to:
identify, from the data storage, a product structure for the product;
retrieve a set of design data related to the product from one or more external data systems via a network;
evaluate each design data of the set of design data to identify at least one relationship with the one or more of the product and the one or more subcomponents, and define an association between each design data and the one or more of the product and the one or more subcomponents based on the at least one relationship;
receive a request to display at least one design document related to the product within a workspace; and
in response to receiving the request to display the at least one design document:
provide, within the workspace, access to the at least one design document;
identify a set of related design data associated with the at least one design document according to the product structure; and
provide access to the set of related design data within the workspace.

10. The system of claim 9, wherein the processor is configured to display the at least one design document within the workspace.

11. The system of claim 10, wherein the processor is configured to:
receive a feedback on the at least one design document displayed within the workspace.

12. The system of claim 11, wherein the processor is configured to:
display the feedback received on the at least one design document when a related design document associated with a higher hierarchical level of the product structure is displayed.

13. The system of claim 9, wherein the processor is configured to:
match at least a part of a design data identifier associated with each design data with one or more of a product identifier associated with the product and a subcomponent identifier of the one or more subcomponents.

14. The system of claim 9, wherein the processor is configured to:
determine a hierarchical level of the product structure to which the at least one design document is associated:
identify, based on the product structure, the one or more subcomponents associated with a lower hierarchical level than the hierarchical level determined for the at least one design document; and
assign one or more design data associated with the one or more subcomponents at the lower hierarchical level as the set of related design data.

15. The system of claim 9, wherein the request to display the at least one design document related to the product comprises a request to display a design document related to a subcomponent of the product.

16. The system of claim 9, wherein each subcomponent is associated with at least an engineering requirement, a bill of materials reference, a design drawing reference, and a CAD model reference.

17. A method for providing collaborative visualization of design data related to a product, the method comprising:
receiving a request to display at least one design document related to the product within a workspace;
identifying a product structure for the product, the product structure defining one or more hierarchical relationships between the product and one or more subcomponents of the product;
providing, within the workspace, access to the at least one design document;
identifying a set of related design data associated with the at least one design document according to the product structure; and
providing access to the set of related design data within the workspace.

18. The method of claim 17, wherein providing, within the workspace, access to the at least one design document comprises:
displaying the at least one design document within the workspace.

19. The method of claim 18 further comprises:
receiving a feedback on the at least one design document displayed within the workspace.

20. The method of claim 19 further comprises:
displaying the feedback received on the at least one design document when a related design document associated with a higher hierarchical level of the product structure is displayed.

21. The method of claim 17, wherein identifying the set of related design data associated with the at least one design document according to the product structure comprises:
determining a hierarchical level of the product structure to which the at least one design document is associated;
identifying, based on the product structure, the one or more subcomponents associated with a lower hierarchical level than the hierarchical level determined for the at least one design document; and
assigning one or more design data associated with the one or more subcomponents at the lower hierarchical level as the set of related design data.

22. The method of claim 17, wherein the request to display the at least one design document related to the product comprises a request to display a design document related to a subcomponent of the product.

23. The method of claim 17, wherein each subcomponent is associated with at least an engineering requirement, a bill of materials reference, a design drawing reference, and a CAD model reference.

24. A system for providing collaborative visualization of design data related to a product, the system comprising:
a data storage operable to store one or more product structures, each product structure defining one or more hierarchical relationships between each product and one or more subcomponents of that product; and
a processor configured to:
receive a request to display at least one design document related to the product within a workspace;
identify a product structure for the product, the product structure defining one or more hierarchical relationships between the product and one or more subcomponents of the product;
provide, within the workspace, access to the at least one design document;
identify a set of related design data associated with the at least one design document according to the product structure; and
provide access to the set of related design data within the workspace.

25. The system of claim 24, wherein the processor is configured to:
display the at least one design document within the workspace.

26. The system of claim 25, wherein the processor is configured to:
receive a feedback on the at least one design document displayed within the workspace.

27. The system of claim 26, wherein the processor is configured to:
display the feedback received on the at least one design document when a related design document associated with a higher hierarchical level of the product structure is displayed.

28. The system of claim 24, wherein the processor is configured to:
determine a hierarchical level of the product structure to which the at least one design document is associated;
identify, based on the product structure, the one or more subcomponents associated with a lower hierarchical level than the hierarchical level determined for the at least one design document; and
assign one or more design data associated with the one or more subcomponents at the lower hierarchical level as the set of related design data.

29. The system of claim 24, wherein the request to display the at least one design document related to the product comprises a request to display a design document related to a subcomponent of the product.

30. The system of claim 24, wherein each subcomponent is associated with at least an engineering requirement, a bill of materials reference, a design drawing reference, and a CAD model reference.
